(19) United States
(12) Patent Application Publication
(10) Pub. No.: US 2013/0152565 A1
(43) Pub. Date: Jun. 20, 2013

(54) HYDRAULIC SYSTEM HAVING ENERGY RECOVERY

(71) Applicants: Pengfei Ma, Naperville, IL (US); Jeffrey L. Kuehn, Germantown Hills, IL (US); Jeremy T. Peterson, Washington, IL (US)

(72) Inventors: Pengfei Ma, Naperville, IL (US); Jeffrey L. Kuehn, Germantown Hills, IL (US); Jeremy T. Peterson, Washington, IL (US)

(21) Appl. No.: 13/328,716

(22) Filed: Dec. 16, 2011

(51) Int. Cl. F15B 1/027

(52) U.S. Cl. 60/327; 60/414

(57) ABSTRACT

A hydraulic system for a machine is disclosed. The hydraulic system may have a pump configured to pressurize fluid, a swing motor driven by pressurized fluid to swing a body of the machine relative to an undercarriage, and a first circuit fluidly connecting the pump to the swing motor. The hydraulic system may also have an energy recovery motor mechanically connected to the swing motor, at least one accumulator, and a second circuit fluidly connecting the at least one accumulator to the energy recovery motor.

### TECHNICAL FIELD

The present disclosure relates generally to a hydraulic system, and more particularly, to a hydraulic system having energy recovery.

### BACKGROUND

Machines such as excavators, draglines, cranes, loaders, and other types of heavy equipment use one or more hydraulic actuators to move a work tool. These actuators are fluidly connected to a pump on the machine that provides pressurized fluid to chambers within the actuators. As the pressurized fluid moves into or through the chambers, the pressure of the fluid acts on hydraulic surfaces of the chambers to affect movement of the actuator and the connected work tool. When the pressurized fluid is drained from the chambers, it is returned to a low pressure sump on the machine.

One problem associated with this type of hydraulic arrangement involves efficiency. In particular, the fluid draining from the actuator chambers to the sump has a pressure greater than the pressure of the fluid already within the sump. As a result, the higher pressure fluid draining into the sump still contains some energy that is wasted upon entering the low pressure sump. This wasted energy reduces the efficiency of the hydraulic system.

One method of improving the efficiency of such a hydraulic system is described in U.S. Pat. No. 7,908,852 issued to Zhang et al. on Mar. 22, 2011 (the '852 patent). The '852 patent discloses a hydraulic system that converts kinetic energy generated by operation of a swing motor into hydraulic potential energy, and reuses the potential energy for subsequent swing motor acceleration. The hydraulic system includes an accumulator that stores exit oil from the swing motor that is pressurized by inertia torque applied on the moving swing motor. The pressurized oil in the accumulator is then selectively supplied back to the swing motor to accelerate the motor.

Although the system of the '852 patent may have improved efficiency compared to a conventional hydraulic system, it may still be less than optimal. Specifically, because the system of the '852 patent accumulates exit oil from the swing motor and returns accumulated oil directly to the swing motor, care must be taken to help ensure that the oil has pressures conducive to capture and reuse. This care may result in a more complicated and/or more expensive system with limited functionality.

The disclosed hydraulic system is directed to overcoming one or more of the problems set forth above and/or other problems known in the art.

### SUMMARY

One aspect of the present disclosure is directed to a hydraulic system for a machine. The hydraulic system may include a pump configured to pressurize fluid, a swing motor driven by pressurized fluid to swing a body of the machine relative to an undercarriage, and a first circuit fluidly connecting the pump to the swing motor. The hydraulic system may also include an energy recovery motor mechanically connected to the swing motor, at least one accumulator, and a second circuit fluidly connecting the at least one accumulator to the energy recovery motor.

Another aspect of the present disclosure is directed to a method of recovering energy in a machine. The method may include pressurizing fluid within a first circuit, and utilizing the pressurized fluid to swing a body of the machine relative to an undercarriage. The method may also include utilizing swinging of the body of the machine to pressurize fluid within a second circuit, and storing fluid pressurized in the second circuit. The method may further include selectively directing stored fluid from the second circuit to swing the body of the machine.

### BRIEF DESCRIPTION OF THE DRAWINGS

FIG. 1 is a diagrammatic illustration of an exemplary disclosed machine;

FIG. 2 is a schematic illustration of an exemplary disclosed hydraulic system that may be used with the machine of FIG. 1;

FIG. 3 is a schematic illustration of a portion of another exemplary disclosed hydraulic system that may be used with the machine of FIG. 1; and

FIG. 4 is a schematic illustration of a portion of yet another exemplary disclosed hydraulic system that may be used with the machine of FIG. 1.

### DETAILED DESCRIPTION

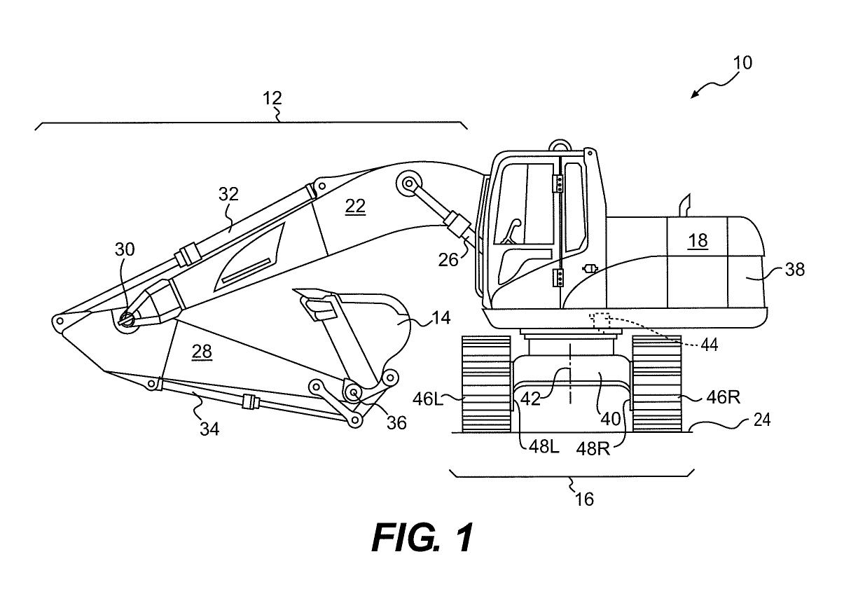

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as an excavator (shown in FIG. 1), a dragline, a front shovel, a backhoe, or another earth moving machine. Machine 10 may include an implement system 12 configured to move a work tool 14, a drive system 16 for propelling machine 10, and a power source 18 that provides power to implement system 12 and drive system 16.

Implement system 12 may include a linkage structure acted on by fluid actuators to move work tool 14. Specifically, implement system 12 may include a boom 22 that is vertically pivotal about a horizontal axis (not shown) relative to a work surface 24 by a pair of adjacent, double-acting, hydraulic cylinders 26 (only one shown in FIG. 1). Implement system 12 may also include a stick 28 that is vertically pivotal about a horizontal axis 30 by a single, double-acting, hydraulic cylinder 32. Implement system 12 may further include a single, double-acting, hydraulic cylinder 34 operatively connected between stick 28 and work tool 14 to pivot work tool 14 vertically about a horizontal pivot axis 36. Boom 22 may be pivotally connected to a body 38 of machine 10. Body 38 may be pivoted relative to an undercarriage 40 about a vertical axis 42 by a hydraulic swing motor 44. Stick 28 may pivotally connect boom 22 to work tool 14 by way of axis 30 and 36. It should be noted that other configurations of implement system 12 may also be possible.

Each of hydraulic cylinders 26, 32, and 34 may include a tube and a piston assembly (not shown) arranged to form two separated pressure chambers (e.g., a head chamber and a rod chamber). The pressure chambers may be selectively supplied with pressurized fluid and drained of the pressurized fluid to cause the piston assembly to displace within the tube, thereby changing an effective length of hydraulic cylinders 26, 32, 34. The flow rate of fluid into and out of the pressure chambers may relate to a velocity of hydraulic cylinders 26, 32, 34, while a pressure differential between the two pressure chambers may relate to a force imparted by hydraulic cylinders 26, 32, 34 on the associated linkage members. The expansion and retraction of hydraulic cylinders 26, 32, 34 may function to assist in moving work tool 14.

Numerous different work tools 14 may be attachable to a single machine 10 and operator controllable. Work tool 14 may include any device used to perform a particular task such as, for example, a bucket, a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 38 of machine 10, work tool 14 may alternatively or additionally rotate, slide, swing, lift, or move in any other manner known in the art.

Swing motor 44, like hydraulic cylinders 26, 32, 34, may be driven by a fluid pressure differential. Specifically, swing motor 44 may include first and second chambers (not shown) located to either side of an impeller (not shown). When the first chamber is filled with pressurized fluid and the second chamber is drained of fluid, the impeller may be urged to rotate in a first direction. Conversely, when the first chamber is drained of fluid and the second chamber is filled with pressurized fluid, the impeller may be urged to rotate in an opposite direction. The flow rate of fluid into and out of the first and second chambers may determine an output rotational velocity of swing motor 44, while a pressure differential across the impeller may determine an output torque.

Drive system 16 may include one or more traction devices powered to propel machine 10. In the disclosed example, drive system 16 includes a left track 46L located on one side of machine 10, and a right track 46R located on an opposing side of machine 10. Left track 46L may be driven by a left travel motor 48L, while right track 46R may be driven by a right travel motor 48R. It is contemplated that drive system 16 could alternatively include traction devices other than tracks such as wheels, belts, or other known traction devices. Machine 10 may be steered by generating a speed and or rotational direction difference between left and right travel motors 48L, 48R, while straight travel may be facilitated by generating substantially equal output speeds and rotational directions from left and right travel motors 48L, 48R.

Similar to swing motor 44, each of left and right travel motors 48L, 48R may be driven by creating a fluid pressure differential. Specifically, each of left and right travel motors 48L, 48R may include first and second chambers (not shown) located to either side of an impeller (not shown). When the first chamber is filled with pressurized fluid and the second chamber is drained of fluid, the impeller may be urged to rotate a corresponding traction device in a first direction. Conversely, when the first chamber is drained of the fluid and the second chamber is filled with the pressurized fluid, the respective impeller may be urged to rotate the traction device in an opposite direction. The flow rate of fluid into and out of the first and second chambers may determine a rotational velocity of left and right travel motors 48L, 48R, while a pressure differential between the chambers may determine a torque.

Power source 18 may embody an engine such as, for example, a diesel engine, a gasoline engine, a gaseous fuel-powered engine, or any other type of combustion engine known in the art. It is contemplated that power source 18 may alternatively embody a non-combustion source of power such as a fuel cell, a power storage device, or another source known in the art. Power source 18 may produce a mechanical or electrical power output that may then be converted to hydraulic power for moving hydraulic cylinders 26, 32, 34 and left travel, right travel, and swing motors 48L, 48R, 44.

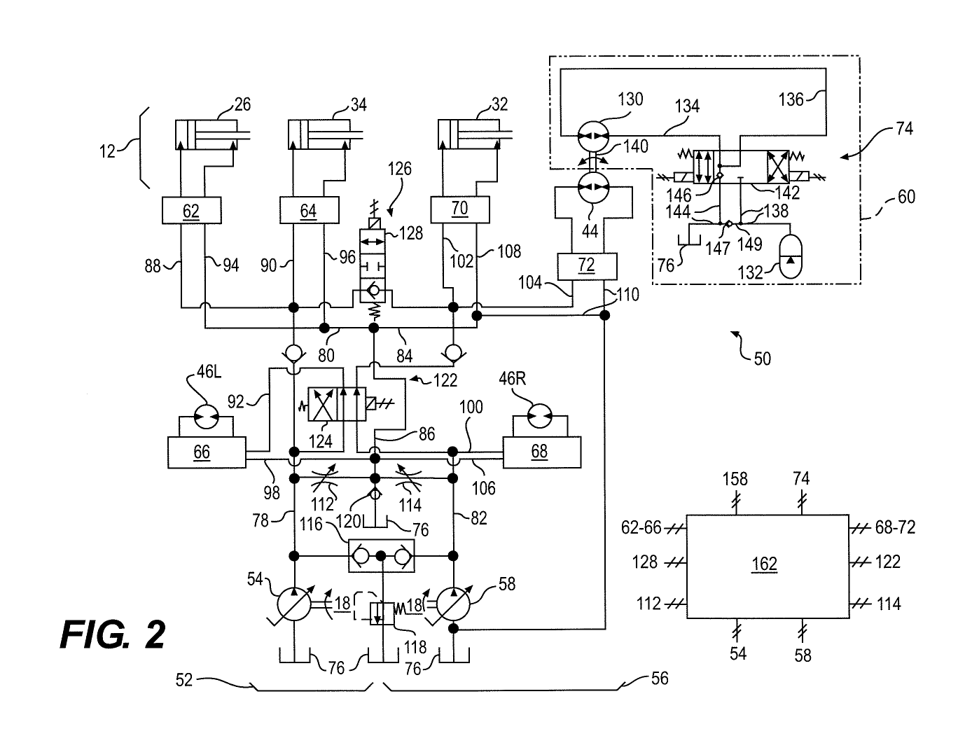

As illustrated in FIG. 2, machine 10 may include a hydraulic system 50 having a plurality of fluid components that cooperate to move work tool 14 (referring to FIG. 1) and machine 10. In particular, hydraulic system 50 may include a first circuit 52 configured to receive a first stream of pressurized fluid from a first source 54, a second circuit 56 configured to receive a second stream of pressurized fluid from a second source 58, and a third circuit 60 configured to selectively transfer energy with second circuit 56. First circuit 52 may include a boom control valve 62, a bucket control valve 64, and a left travel control valve 66 connected in parallel to receive the first stream of pressurized fluid. Second circuit 56 may include a right travel control valve 68, a stick control valve 70, and a swing control valve 72 connected in parallel to receive the second stream of pressurized fluid. Third circuit 60 may include an accumulator control valve 74. It is contemplated that additional control valve mechanisms may be included within first, second, and/or third circuits 52, 56, 60 such as, for example, one or more attachment control valves and other suitable control valve mechanisms.

First and second sources 54, 58 may be configured to draw fluid from one or more tanks 76 and pressurize the fluid to desired levels. Specifically, each of first and second sources 54, 58 may embody a pumping mechanism such as, for example, a variable displacement pump (shown in FIG. 2), a fixed displacement pump, or any other source known in the art. First and second sources 54, 58 may each be separately and drivably connected to power source 18 of machine 10 by, for example, a countershaft (not shown), a belt (not shown), an electrical circuit (not shown), or in any other suitable manner. Alternatively, each of first and second sources 54, 58 may be indirectly connected to power source 18 via a torque converter, a reduction gear box, an electrical circuit, or in any other suitable manner. First source 54 may produce the first stream of pressurized fluid independent of the second stream of pressurized fluid produced by second source 58. The outputs of first and second sources 54, 58 may be at different pressure levels and flow rates and determined at least in part by the pressures of the fluid within first and second circuits 52, 56.

Tank 76 may constitute a reservoir configured to hold a supply of fluid. The fluid may include, for example, a dedicated hydraulic oil, an engine lubrication oil, a transmission lubrication oil, or any other fluid known in the art. One or more hydraulic systems within machine 10 may draw fluid from and return fluid to tank 76. It is contemplated that hydraulic system 50 may be connected to multiple separate fluid tanks or to a single tank, as desired.

Each of boom, bucket, right travel, left travel, stick, and swing control valves 62-74 may regulate the motion of their related fluid actuator(s). Specifically, boom control valve 62 may have elements movable to control the motion of hydraulic cylinders 26 associated with boom 22; bucket control valve 64 may have elements movable to control the motion of hydraulic cylinder 34 associated with work tool 14; stick control valve 70 may have elements movable to control the motion of hydraulic cylinder 32 associated with stick 28; and swing control valve 72 may have elements movable to control the swinging motion of body 38 about vertical axis 42. Likewise, left travel control valve 66 may have valve elements movable to control the motion of left travel motor 48L, while right travel control valve 68 may have elements movable to control the motion of right travel motor 48R.

The control valves of first and second circuits 52, 56 may allow pressurized fluid to flow to and drain from their respective actuators via common passages. Specifically, the control valves of first circuit 52 may be connected to first source 54 by way of a first supply passage 78, and to tank 76 by way of a first drain passage 80. The control valves of second circuit 56 may likewise be connected to second source 58 by way of a second supply passage 82, and to tank 76 by way of a second drain passage 84. First and second drain passages 80, 84 may connect to a common drain passage 86 that terminates at tank 76. Boom, bucket, and left travel control valves 62-66 may be connected in parallel to first supply passage 78 by way of individual fluid passages 88, 90, and 92, respectively, and in parallel to first and/or common drain passages 80, 86 by way of individual fluid passages 94, 96, and 98, respectively. Similarly, right travel, stick, and swing control valves 68-72 may be connected in parallel to second supply passage 82 by way of individual fluid passages 100, 102, and 104, respectively, and in parallel to second and/or common drain passages 84, 86 by way of individual fluid passages 106, 108, and 110, respectively. It is contemplated that check valves (not shown) may be disposed within any or all of fluid passages 88-92 and 100-104 to provide for a unidirectional supply of pressurized fluid to the respective control valves, if desired.

Because the elements of boom, bucket, left travel, right travel, stick, and swing control valves 62-72 may be similar and function in a related manner, only the operation of swing control valve 72 will be discussed in this disclosure. In one example, swing control valve 72 may include a first chamber supply element (not shown), a first chamber drain element (not shown), a second chamber supply element (not shown), and a second chamber drain element (not shown). The first and second chamber supply elements may be connected in parallel with fluid passage 104 to fill their respective chambers with fluid from second source 58, while the first and second chamber drain elements may be connected in parallel with fluid passage 110 to drain the respective chambers of fluid. To rotate swing motor 44 in a first direction, the first chamber supply element may be shifted to allow pressurized fluid from second source 58 to fill the first chamber of swing motor 44 via fluid passage 104, while the second chamber drain element may be shifted to drain fluid from the second chamber of swing motor 44 to tank 76 via fluid passage 110. To rotate swing motor 44 in the opposite direction, the second chamber supply element may be shifted to fill the second chamber of swing motor 44 with pressurized fluid, while the first chamber drain element may be shifted to drain fluid from the first chamber of swing motor 44. It is contemplated that both the supply and drain functions of a particular control valve may alternatively be performed by a single element associated with the first chamber and a single element associated with the second chamber or by a single element associated with both the first and second chambers, if desired.

The supply and drain elements of each of control valves 62-72 may be solenoid movable against a spring bias in response to a commanded flow rate. That is, to achieve an operator-desired tool and/or machine velocity, a command based on an assumed or measured pressure may be sent to the solenoids (not shown) of the supply and drain elements that causes them to open an amount corresponding to the necessary flow rate. The command may be in the form of a flow rate command or a valve element position command. Hydraulic cylinders 26, 32, 34 and left travel, right travel, and swing motors 48L, 48R, and 44 may move at a velocity that corresponds to the flow rate of fluid into and out of the first and second chambers.

The supply and drain passages of first and second circuits 52, 56 may be interconnected for makeup and relief functions. In particular, first and second supply passages 78, 82 may receive makeup fluid from tank 76 by way of first and second bypass elements 112, 114, respectively. As the pressure of the first or second streams drops below a predetermined level, fluid from tank 76 may be allowed to flow into first and second circuits 52, 56 by way of first and second bypass elements 112, 114. It is contemplated that a filter (not shown) may be associated with first and/or second bypass elements 112, 114 to filter the flow of makeup fluid, if desired. First and second supply passages 78, 82 may relieve fluid from first and second circuits 52, 56 to tank 76 by way of a shuttle valve 116 and a common main relief element 118. As fluid within first or second circuits 52, 56 exceeds a desired level, fluid from the circuit having the excessive pressure may drain to tank 76 by way of shuttle valve 116 and common main relief element 118. In a similar manner, fluid may drain from first and second circuits 52, 56 via a check valve 120 located within common drain passage 86. In this arrangement, a pressure setting of check valve 120 may be lower than a pressure setting of common main relief element 118.

A straight travel valve 122 may selectively rearrange left and right travel control valves 66, 68 into a series relationship with each other. In particular, straight travel valve 122 may include a spring-biased, solenoid-activated valve element 124 that is movable from a neutral position (shown in FIG. 1) toward a straight travel position. When valve element 124 is in the neutral position, left and right travel control valves 66, 68 may be independently supplied with pressurized fluid from first and second sources 54, 58, respectively, to control left and right travel motors 48L, 48R separately. However, when valve element 124 is in the straight travel position, left and right travel control valves 66, 68 may be connected in series to receive pressurized fluid from only second source 58 for dependent movement. When only travel commands are active (e.g., no implement commands are active), valve element 124 may be maintained in the neutral position. If loading of left and right travel motors 48L, 48R is unequal (e.g., left track 46L is on soft ground while right track 46R is on concrete), the separation of first and second sources 54, 58 via straight travel valve 122 may provide for straight travel, even with differing output pressures from first and second sources 54, 58.

Straight travel valve 122 may also be actuated to support implement control during travel of machine 10. For example, if an operator actuates boom control valve 62 during travel of machine 10, valve element 124 of straight travel valve 122 may move to supply left and right travel motors 48L, 48R with pressurized fluid from second source 58 while boom control valve 62 may receive pressurized fluid from first source 54. Valve element 124 may be spring biased toward the straight travel position and solenoid-activated to move toward the neutral position.

When valve element 124 of straight travel valve 122 is moved to the straight travel position, fluid from first source 54 may be substantially simultaneously directed via valve element 124 through both first and second circuits 52, 56 to drive hydraulic cylinders 26, 32, 34. The second stream of pressurized fluid from first source 54 may be directed to hydraulic cylinders 26, 32, 34 of both first and second circuits 52, 56 because all of the first stream of pressurized fluid from first source 54 may be nearly completely consumed by left and right travel motors 48L, 48R during straight travel of machine 10.

A combiner valve 126 may combine the first and second streams of pressurized fluids from first and second supply passages 78, 82 for high speed movement of one or more fluid actuators. In particular, combiner valve 126 may include a spring-biased, solenoid-activated valve element 128 that is movable between a neutral position (shown in FIG. 1), a flow-blocking position, and a bidirectional flow-passing position. When in the neutral position, fluid from first circuit 52 may be allowed to flow into second circuit 56 in response to the pressure of first circuit 52 being greater than the pressure within second circuit 56 by a predetermined amount. The predetermined amount may be related to a spring bias and fixed during a manufacturing process. In this manner, when a right travel or stick function requires a rate of fluid flow greater than an output capacity of second source 58 and the pressure within second circuit 56 begins to drop, fluid from first source 54 may be diverted to second circuit 56 by way of valve element 128. When in the bidirectional flow-passing position, the second stream of pressurized fluid may be allowed to flow to first circuit 52 to combine with the first stream of pressurized fluid directed to control valves 62-66. Valve element 128 may be spring-biased toward the neutral position, and solenoid activated to move toward the bidirectional flow-passing position.

Third circuit 60 may function as an energy recovery circuit that is hydraulically separate from (i.e., substantially fluidly isolated from) first and second circuits 52, 56 and configured to selectively accumulate energy from and discharge energy to second circuit 56. Third circuit 60 may include, among other things, an energy recovery motor (ERM) 130 that is mechanically connected to swing motor 44, and at least one accumulator that is fluidly coupled to ERM 130. In the embodiment of FIG. 2, third circuit 60 includes a single accumulator 132 that is fluidly coupled to ERM 130 by way of first and second motor passages 134, 136 and an accumulator passage 138. Accumulator control valve 74 may be disposed between accumulator passage 138 and first and second motor passages 134, 136 to control fluid communication therebetween.

ERM 130, like the other motors of hydraulic system 50, may be driven by creating a fluid pressure differential across a pumping mechanism. Specifically, ERM 130 may include first and second chambers (not shown) located to either side of the pumping mechanism (e.g., an impeller or series of pistons). When the first chamber is filled with pressurized fluid and the second chamber is drained of fluid, the pumping mechanism may be urged to rotate a corresponding shaft 140 in a first direction. Conversely, when the first chamber is drained of the fluid and the second chamber is filled with the pressurized fluid, the pumping mechanism may be urged to rotate shaft 140 in an opposite direction. Because ERM 130 may be mechanically connected to swing motor 44 (e.g., via shaft 140), any rotation of the pump mechanism described above may result in a corresponding rotation of swing motor 44 (e.g., a rotation that drives the swinging motion of body 38 relative to undercarriage 40 - referring to FIG. 1). The flow rate of fluid into and out of the first and second chambers of ERM 130 may determine a rotational velocity of shaft 140, while a pressure differential between the chambers may determine a torque associated with the rotation.

In the exemplary embodiment of FIG. 2, ERM 130 is shown as a non-overcenter, fixed-displacement type of motor. That is, ERM 130 may be configured to receive a first flow of pressurized fluid (e.g., from first motor passage 134) and rotate in a corresponding first direction at a fixed speed and/or with a fixed torque that is directly related to a pressure and flow rate of the fluid. To rotate in a second direction, energy recovery motor 130 must be provided with a second opposing flow of pressurized fluid (e.g., from second motor passage 136). ERM 130, in the embodiment of FIG. 2, may not be adjustable to vary a direction, speed, or torque of shaft 140 for a given flow of pressurized fluid.

ERM 130 may also selectively function as a pump. In particular, shaft 140 of ERM 130 may be mechanically driven by rotation of swing motor 44 to thereby drive the pumping mechanism of ERM 130 and pressurize fluid within third circuit 60. The fluid within third circuit 60 may be selectively pressurized by ERM 130, for example, at an end of a swinging operation such that the process of pressurizing the fluid creates resistance to the swinging motion. The resistance created by ERM 130 at the end of the swinging operation may function to slow the swinging motion of machine 10. The fluid pressurized by ERM 130, as will be described in more detail below, may be stored within accumulator 132 and selectively reused at a later time to accelerate swing motor 44 and initiate swinging of body 38 relative to undercarriage 40. In this manner, ERM 130 may be used to selectively initiate and brake swinging operations of machine 10, thereby improving responsiveness and/or efficiency of machine 10.

Accumulator 132 may be a pressure vessel filled with a compressible gas that is configured to store pressurized fluid for future use as a source of power. The compressible gas may include, for example, nitrogen, argon, helium, or another appropriate compressible gas. As fluid in communication with accumulator 132 exceeds a pressure within accumulator 132, the fluid may flow into accumulator 132. Because the gas therein is compressible, it may act like a spring and compress as the fluid flows into accumulator 132. When the pressure of the fluid within accumulator passage 138 drops below a pressure within accumulator 132, the compressed gas may expand and urge the fluid from within accumulator 132 to exit. It is contemplated that accumulator 132 may alternatively embody a spring-biased types of accumulator, if desired. Accumulator 132, in the exemplary embodiment, may be designed to operate within a range of about 150-200 bar.

Accumulator control valve 74, in the exemplary embodiment of FIG. 1, may be a four-way, three-position, solenoid-operated valve. In particular, accumulator control valve 74 may include a valve element 142 that is movable between a first position at which fluid from accumulator 132 flows into ERM 130 in a first direction via first motor passage 134 and fluid exiting ERM 130 is directed into tank 76 via second motor passage 136 and a drain passage 144, a second position at which fluid from accumulator 132 flows into ERM 130 in a second direction via second motor passage 136 and fluid exiting ERM 130 is directed into tank 76 via first motor passage 134 and drain passage 144, and a third position (shown in FIG. 2) at which accumulator 132 is substantially isolated from ERM 130 and tank 76 is selectively connected to only supply fluid to ERM 130 via drain passage 144 and either of first and second motor passages 134, 136 (e.g., based on a pressure of fluid within third circuit 60). The third position of accumulator control valve 74 may correspond with a “free wheel” position, in which ERM 130 is neither significantly accelerating nor decelerating swing motor 44. When valve element 142 is in the third position, makeup fluid from tank 76 may be allowed to flow past a check element 146 associated with accumulator control valve 74 before entering first or second motor passages 134, 136 (depending on a pressure of the passages). An additional check element 147 may be located within a passage 149 that extends between drain passage 144 and accumulator passage 138 to selectively allow makeup fluid to pass into accumulator passage 138 based on a pressure differential across check element 147. Accumulator control valve 74 may be solenoid-operated to move to the first or second positions, and spring-biased toward the third position.

A controller 162 may be in communication with the different components of hydraulic system 50 to regulate operations of machine 10. For example, controller 162 may be in communication with control valves 62-72, straight travel valve 122, combiner valve 126, accumulator control valve 74, bypass elements 112, 114, operator input devices (not shown), and other components of hydraulic system 50 and/or machine 10. Based on various operator input and monitored parameters, as will be described in more detail below, controller 162 may be configured to selectively activate the different valves and/or pumps in a coordinated manner to efficiently carry out operator commands. The operational parameters monitored by controller 162 may include, for example, fluid pressures, temperatures, viscosities, densities, etc.

Controller 162 may include a memory, a secondary storage device, a clock, and one or more processors that cooperate to accomplish a task consistent with the present disclosure. Numerous commercially available microprocessors can be configured to perform the functions of controller 162. It should be appreciated that controller 162 could readily embody a general machine controller capable of controlling numerous other functions of machine 10. Various known circuits may be associated with controller 162, including signal-conditioning circuitry, communication circuitry, and other appropriate circuitry. It should also be appreciated that controller 162 may include one or more of an application-specific integrated circuit (ASIC), a field-programmable gate array (FPGA), a computer system, and a logic circuit configured to allow controller 162 to function in accordance with the present disclosure

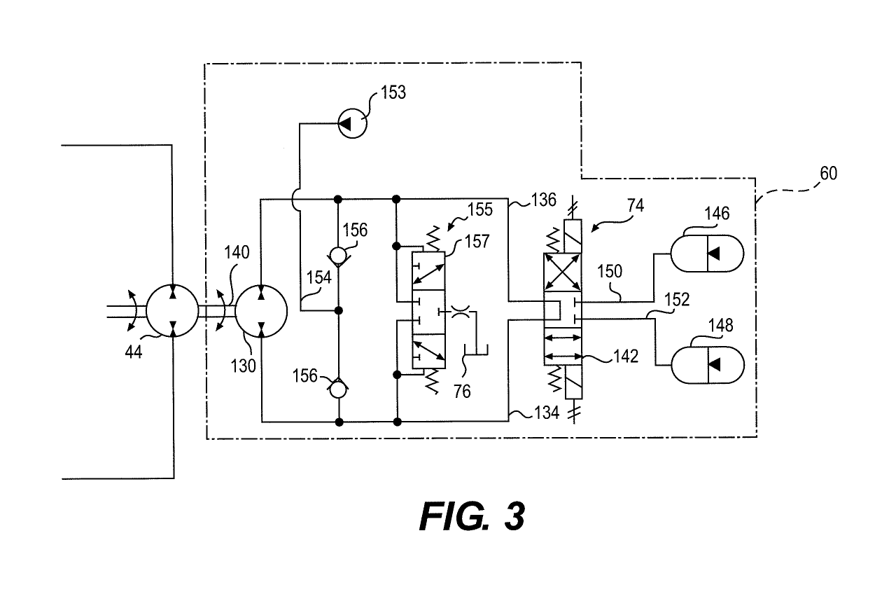

FIG. 3 illustrates an alternative embodiment of third circuit 60. Similar to the embodiment of FIG. 2, third circuit 60 of FIG. 3 also includes ERM 130, first and second motor passages 134, 136, and accumulator control valve 74. In contrast to the embodiment of FIG. 2, however, third circuit 60 of FIG. 3 includes two different accumulators, for example a high-pressure accumulator 146 and a low-pressure accumulator 148, that are simultaneously connectable to accumulator control valve 74 via first and second accumulator passages 150, 152. In addition, a charge pump 153 may be connected to first and second motor passages 134, 136 via a makeup circuit 154 and makeup check valves 156, and a flushing circuit 155 having a flushing control valve 157 may connect first and second motor passages 134, 136 to tank 76. In this configuration, when valve element 142 of accumulator control valve 74 is in the first or second positions, high-pressure accumulator 146 may be connected to either the inlet or outlet of ERM 130, functioning to either accelerate or decelerate ERM 130 (and swing motor 44). At this same time, low-pressure accumulator 148 may be connected in opposition to high-pressure accumulator 146 to act against high-pressure accumulator 146. The net effect of the two accumulators acting against each other may be a torque driven by a difference in fluid pressures between high- and low-pressure accumulators 146, 148 that either accelerates or decelerates ERM 130. The use of two accumulators in the embodiment of FIG. 3 may enhance controllability and/or stability of the swinging motion of machine 10 during energy recovery operations.

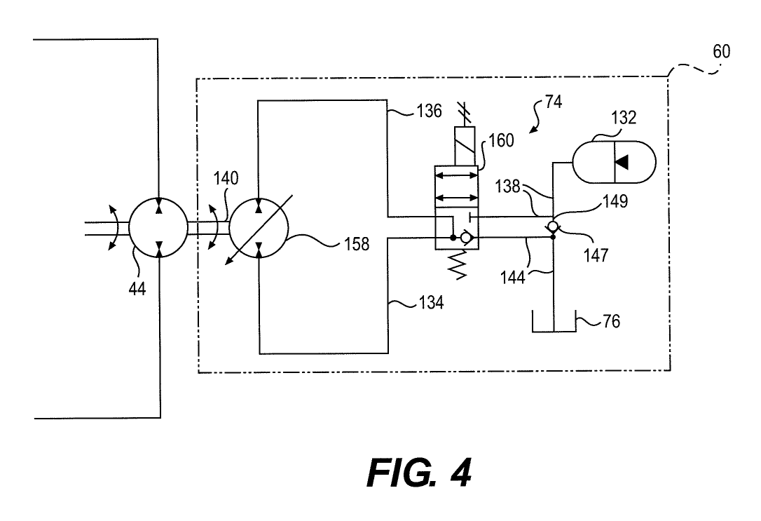

FIG. 4 illustrates another alternative embodiment of third circuit 60. Similar to the embodiment of FIG. 2, third circuit 60 of FIG. 4 also includes the single accumulator 132 connected to first and second pump passages 134, 136 via accumulator control valve 74. In contrast to the embodiment of FIG. 2, however, ERM 130 has been replaced with a different ERM (energy recovery motor) 158 in the embodiment of FIG. 4. In addition, accumulator control valve 74, in the embodiment of FIG. 4, includes a two-position valve element 160, as opposed to the three-position valve element 142 of FIG. 2.

ERM 158 may be a variable-displacement, overcenter type motor. In particular, pressurized fluid from third circuit 60 may be directed into ERM 158 in only a single direction (e.g., via only second motor passage 136) and, for this given direction of fluid flow, ERM 158 may be controllable to adjust a rotational direction, speed, and/or torque of shaft 140. Because ERM 158 may have the ability to adjust the rotational direction of shaft 140 for a given flow direction, valve element 160 of accumulator control valve 74 may need only to move between a first position and a second position to adequately control operation of ERM 158. The first position of valve element 160 may correspond with the first position of valve element 142 (referring to FIG. 2), while the second position of valve element 160 may correspond with the third position of valve element 142. The second position of valve element 142 may be omitted from valve element 160.

Industrial Applicability

The disclosed hydraulic system may be applicable to any machine having a swing motor, where high efficiency and performance is desired. The disclosed hydraulic system may improve efficiency by selectively recovering otherwise wasted energy during an end portion of a swing operation. The disclosed hydraulic system may also improve performance by using the stored energy to accelerate swinging of the machine during a subsequent operation. The operation of hydraulic system 50 will now be explained.

During operation of machine 10 (referring to FIG. 1), a machine operator may manipulate an operator interface device (not shown) to cause a corresponding movement of machine 10. For example, the operator may manipulate an operator input device to initiate swinging of body 38 relative to undercarriage 40. The actuation position of the operator interface device may be related to an operator-expected or desired swing direction, velocity, and/or torque. The operator interface device may generate a position signal indicative of the operator-expected or desired movement during manipulation thereof, and send this position signal to controller 162.

Controller 162 may receive the operator interface device position signal and determine commands for control valve 72 and second source 58 (referring to FIG. 2) that correspond with the operator-desired movements of machine 10. Controller 162 may then command activation of control valve 72 to direct pressurized fluid from second source 58 to swing motor 44 that results in movement in the manner desired by the operator.

During the swinging movement of machine 10, it may be possible for energy to be wasted toward an end of a swing, when the momentum of machine 10 is still significant but swinging movement is no longer desired. That is, at the end of a swing of body 38 (and attached implement system 12), after controller 162 has caused pressurized fluid from second source 58 to stop driving swing motor 44, the centrifugal momentum of machine 10 may cause body 38 and swing motor 44 to continue rotating. Normally, in conventional hydraulic systems, the energy associated with the still-swinging machine body ends up driving swing motor 44 as a pump to pressurize fluid that is subsequently wasted within tank 76. In the disclosed embodiment of hydraulic system 50, however, the swinging momentum of machine 10 may be recovered at the end of the swinging movement through the use of ERM 130 and accumulator 132.

To extract the momentum-related energy normally wasted during the swinging of body 38, ERM 130 may be driven by the rotation of swing motor 44 to operate like a pump and pressurize fluid within third circuit 60. The pressurizing of fluid by ERM 130 may create resistance to the rotation of swing motor 44, thereby helping to slow body 38 faster than otherwise possible. This faster deceleration provided by ERM 130 may allow swing motor 44 to be driven to a higher average speed during earlier portions of the swinging movement, thereby improving the performance of machine 10. At the same time, the fluid pressurized by ERM 130 may be passed through accumulator control valve 74 (which may be moved to an appropriate position by controller 162 according to the rotational direction of swing motor 44) into accumulator 132 where it can be stored for future use in accelerating subsequent swinging of machine 10. As accumulator 132 fills with pressurizing fluid, the back pressure within third circuit 60 may increase, thereby further increasing resistance to the rotation of body 38.

At any time during operation of machine 10, when controller 162 determines it to be most beneficial, accumulator control valve 74 may be moved to a discharge position (i.e., one of the first and second positions depending on the rotational direction of ERM 130) at which pressurized fluid stored within swing accumulator 132 may flow back through accumulator control valve 74 and one of first and second pump passages 134, 136 to drive ERM 130. This fluid, because of its elevated pressure, may cause ERM 130 to rotate swing motor 44 via shaft 140, thereby reducing a load on second source 58 and power source 18, increasing a velocity of swing motor 44, and/or increasing the efficiency of machine 10. Operation of third circuit 60 disclosed in FIGS. 3 and 4 may be similar to the operation described above with respect to FIG. 2.

The disclosed hydraulic system may be simple and inexpensive. In particular, because the disclosed hydraulic system utilizes a separate hydraulic circuit (i.e., third circuit 60) to recover swing energy, control over fluid pressures during the recovery and during reuse may be unimportant. That is, because third circuit 60 may be substantially fluidly isolated from second circuit 56, it may not be necessary to match fluid pressures between second and third circuits 56, 60 before, during, or after a recovery or reuse operation. This may allow for system operation without pressure monitoring equipment or control, thereby resulting in a simplified and less expensive system. In addition, by not requiring pressure matching before, during, or after energy recovery or reuse operations, there may be more opportunities to recover and/or reuse momentum-related energy, thereby further enhancing performance and/or efficiency of machine 10. Finally, the separate nature of third circuit 60 may allow for simple retrofitting to existing machine systems.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents.

What is claimed is:

1. A hydraulic system for a machine, comprising:
a pump configured to pressurize fluid;
a swing motor driven by pressurized fluid to swing a body of the machine relative to an undercarriage;
a first circuit fluidly connecting the pump to the swing motor;
an energy recovery motor mechanically connected to the swing motor;
at least one accumulator; and
a second circuit fluidly connecting the at least one accumulator to the energy recovery motor.

2. The hydraulic system of claim 1, further including a valve disposed between the energy recovery motor and the at least one accumulator, the valve movable to regulate fluid flow into and out of the at least one accumulator.

3. The hydraulic system of claim 2, further including a tank configured to hold a supply of fluid for the pump, wherein the valve is movable between:
a first position at which fluid from the at least one accumulator flows into the energy recovery motor in a first direction and fluid from the energy recovery motor is directed into the tank;
a second position at which fluid from the at least one accumulator flows into the energy recovery motor in a second direction and fluid from the energy recovery motor is directed into the tank; and
a third position at which the at least one accumulator is substantially isolated from the energy recovery motor and the tank is selectively connected to supply fluid to the energy recovery motor based on a pressure of fluid within the second circuit.

4. The hydraulic system of claim 3, wherein the valve is solenoid-operated to move from the third position to either of the first and second positions, and spring-biased toward the third position.

5. The hydraulic system of claim 1, wherein the energy recovery motor is a non-overcenter motor.

6. The hydraulic system of claim 1, wherein the at least one accumulator includes first and second accumulators.

7. The hydraulic system of claim 6, wherein:
the first accumulator is a high-pressure accumulator; and
the second accumulator is a low-pressure accumulator.

8. The hydraulic system of claim 7, wherein the first and second accumulators are simultaneously connectable to the energy recovery motor.

9. The hydraulic system of claim 8, wherein:
when the first accumulator is connected to an inlet of the energy recovery motor, the second accumulator is connected to an outlet of the energy recovery motor; and
when the first accumulator is connected to the outlet of the energy recovery motor, the second accumulator is connected to an inlet of the energy recovery motor.

10. The hydraulic system of claim 9, wherein the first accumulator is:
connected to the inlet of the energy recovery motor during a braking operation; and
connected to the outlet of the energy recovery motor during an accelerating operation.

11. The hydraulic system of claim 6, further including:
a tank;
a makeup passage fluidly connecting the tank to the second circuit; and
at least one makeup valve disposed within the makeup passage and configured to allow fluid to pass only into the second circuit from the tank.

12. The hydraulic system of claim 1, wherein:
the energy recovery motor is an overcenter motor; and
fluid flow through the energy recovery motor in only a single direction.

13. The hydraulic system of claim 12, further including:
a tank; and
a valve disposed between the at least one accumulator and the energy recovery motor,
wherein the valve is movable from a first position at which fluid from the at least one accumulator flows into the energy recovery motor and fluid from the energy recovery motor flows into the tank, to a second position at which the at least one accumulator is substantially isolated from the energy recovery motor and the tank is selectively fluidly connected to an inlet and an outlet of the energy recovery motor based on a pressure of the second circuit.

14. The hydraulic system of claim 13, further including:
a passage fluidly connecting the tank with the at least one accumulator and the valve; and
a check valve disposed within the passage.

15. The hydraulic system of claim 1, wherein:
the pump is a first pump; and
the hydraulic system further includes:
a hydraulic cylinder;
a second pump configured to pressurize fluid; and
a third circuit fluidly connecting the second pump with the hydraulic cylinder.

16. A method of recovering energy in a machine, comprising:
pressurizing fluid within a first circuit;
utilizing the pressurized fluid to swing a body of the machine relative to an undercarriage;
utilizing swinging of the body of the machine to pressurize fluid within a second circuit;
storing fluid pressurized in the second circuit; and
selectively directing stored fluid from the second circuit to swing the body of the machine.

17. The method of claim 16, wherein selectively directing stored fluid from the second circuit to swing the body of the machine includes selectively directing stored fluid in two different directions through a motor to swing the body of the machine in two different directions.

18. The method of claim 16, wherein selectively directing stored fluid from the second circuit to swing the body of the machine includes selectively directing stored fluid in only a single direction through a motor during swinging of the body of the machine in two different directions.

19. The method of claim 16, wherein storing fluid pressurized in the second circuit includes storing fluid pressurized in the second circuit in a high-pressure accumulator and in a low-pressure accumulator.

20. A machine, comprising:
an engine an undercarriage drive by the engine to propel the machine;
a body;
a swing motor configured to swing the body relative to the undercarriage;
a tank;
a pump driven by the engine to draw fluid from the tank, pressurize the fluid, and direct the pressurized fluid to the swing motor via a first circuit;
an energy recovery motor mechanically connected to the swing motor;
at least one accumulator;
a second circuit fluidly connecting the at least one accumulator to the energy recovery motor; and
a solenoid-operated valve disposed between the energy recovery motor and the at least one accumulator, the solenoid-operated valve being movable to regulate fluid flow into the at least one accumulator during braking of the swing motor and out of the at least one accumulator during accelerating of the swing motor.
